(19) United States
(12) Patent Application Publication
(10) Pub. No.: US 2019/0394733 A1
(43) Pub. Date: Dec. 26, 2019

(54) UL TRANSMISSION UTILIZING FULL TX POWER AT UE

(71) Applicant: Mediatek Inc., Hsin-Chu (TW)

(72) Inventors: Weidong Yang, San Jose, CA (US); Tzu-Han Chou, San Jose, CA (US); Chao-Cheng Su, Hsinchu (TW)

(21) Appl. No.: 16/445,592

(22) Filed: Jun. 19, 2019

Related U.S. Application Data
(60) Provisional application No. 62/687,736, filed on Jun. 20, 2018.

(51) Int. Cl. H04W 52/42; H04W 52/14; H04B 1/04; H04B 7/0404; H04B 7/0456

(52) U.S. Cl. CPC H04W 52/42; H04W 52/146; H04B 2001/0416; H04B 7/0404; H04B 7/0456; H04B 1/0458

(57) ABSTRACT

In an aspect of the disclosure, a method, a computer-readable medium, and an apparatus are provided. The apparatus may be a UE. The UE reports, to a base station, a transmit capability of the UE. The UE receives, from the base station, a first signaling indicating a subset of codewords in a codebook and a second signaling selecting one of the codewords in the subset for precoding an uplink channel for transmission through a plurality of antenna ports over one or more spatial layers.

### CROSS-REFERENCE TO RELATED APPLICATION(S)

This application claims the benefits of U.S. Provisional Application Ser. No. 62/687,736, entitled “UL TRANSMISSION UTILIZING FULL TX POWER AT A UE” and filed on Jun. 20, 2018, which is expressly incorporated by reference herein in their entirety.

### BACKGROUND

### Field

The present disclosure relates generally to communication systems, and more particularly, to techniques of releasing a protocol data unit (PDU) session by a user equipment (UE).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. In an aspect of the disclosure, a method, a computer-readable medium, and an apparatus are provided. The apparatus may be a UE. The UE reports, to a base station, a transmit capability of the UE. The UE receives, from the base station, a first signaling indicating a subset of codewords in a codebook and a second signaling selecting one of the codewords in the subset for precoding an uplink channel for transmission through a plurality of antenna ports over one or more spatial layers.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating uplink transmission at a UE 704.

FIG. 8 is a diagram illustrating a codebook.

FIG. 9A shows a table listing number of codewords allocated to full coherent transmission, partially coherent transmission, and non-coherent transmission.

FIG. 9B shows a table listing number of codewords available for use in a full coherent transmission, a partially coherent transmission, and a non-coherent transmission.

FIG. 10 is a diagram illustrating uplink transmission at a UE.

FIG. 11 is a flow chart of a method (process) for transmitting an uplink channel.

FIG. 12 is another flow chart of a method (process) for transmitting an uplink channel.

FIG. 13 is a conceptual data flow diagram illustrating the data flow between different components/means in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

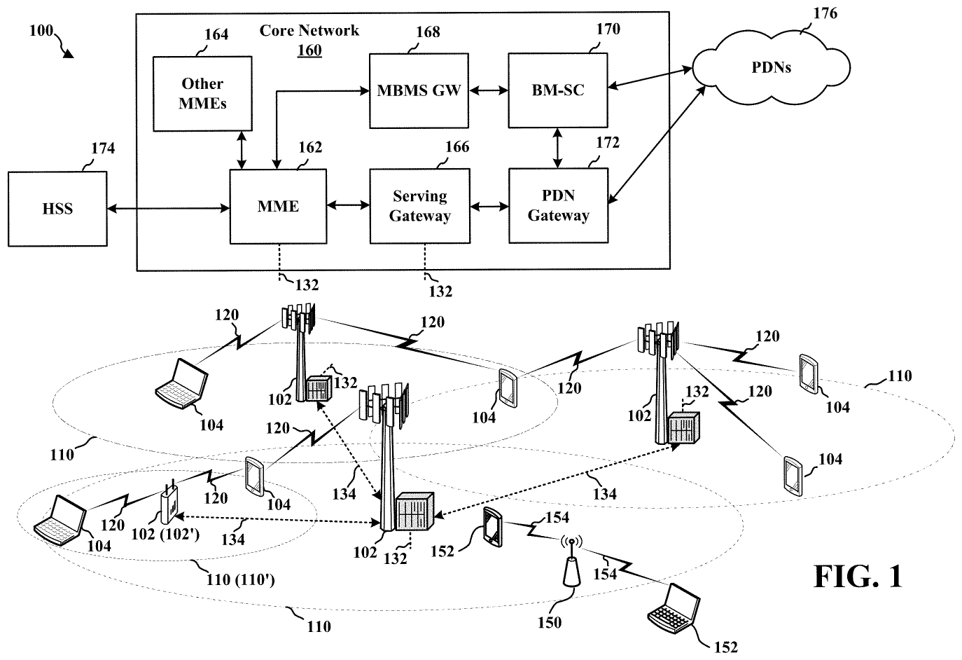

FIG. 1 is a diagram illustrating an example of a wireless communications system and an access network 100. The wireless communications system (also referred to as a wireless wide area network (WWAN)) includes base stations 102, UEs 104, and a core network 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the core network 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the core network 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The core network 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the core network 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the core network 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

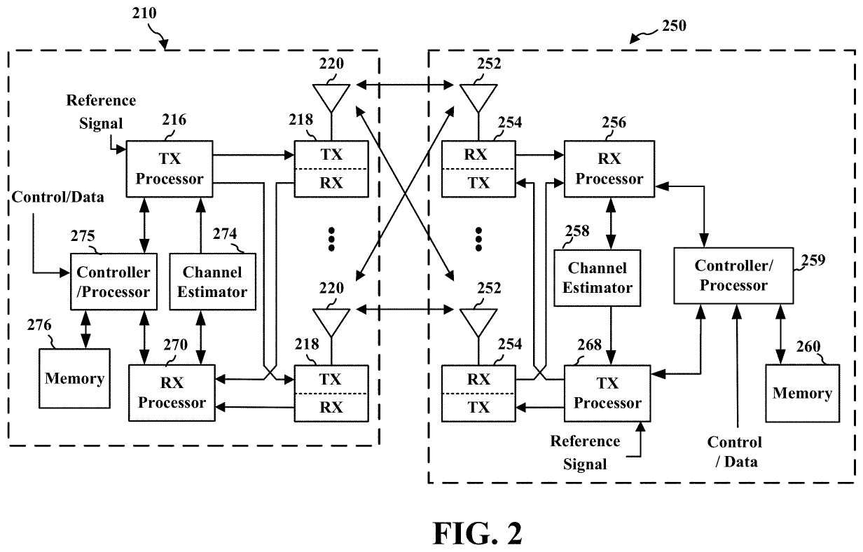

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

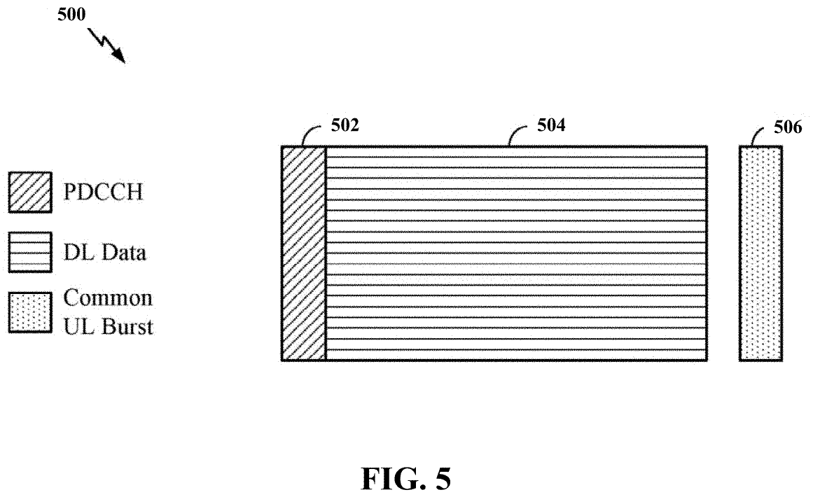

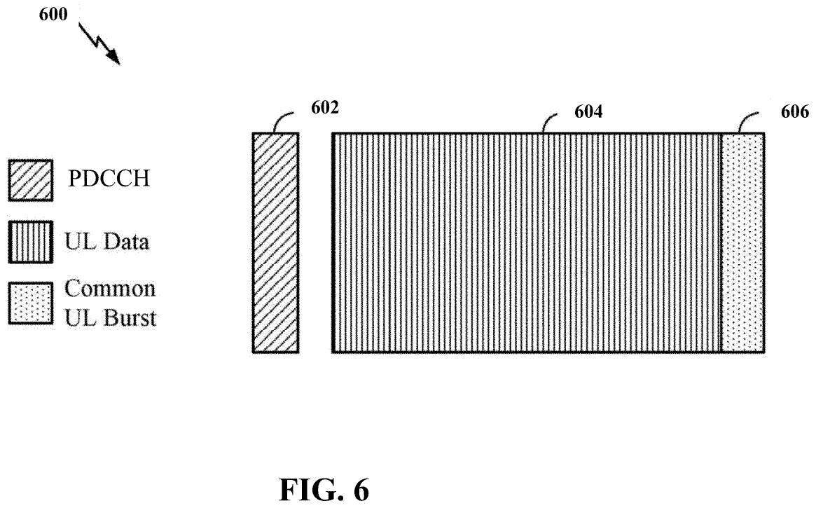

A single component carrier bandwidth of 100 MHZ may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

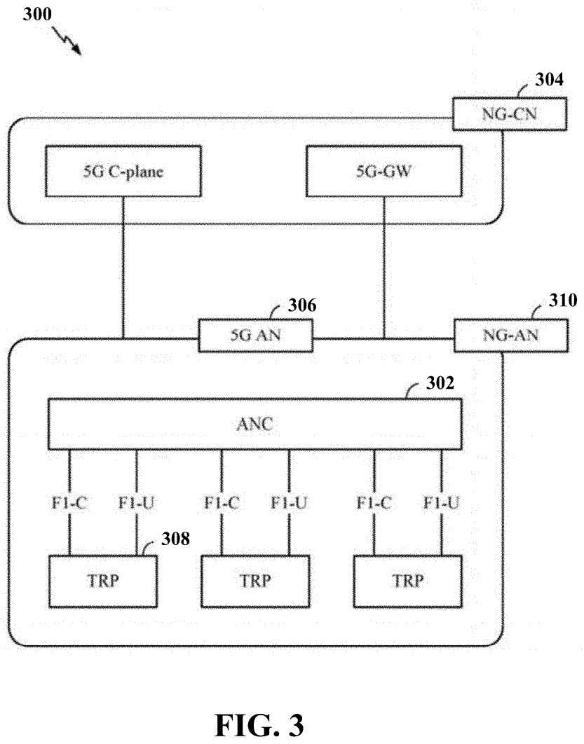

FIG. 3 illustrates an example logical architecture 300 of a distributed RAN, according to aspects of the present disclosure. A 5G access node 306 may include an access node controller (ANC) 302. The ANC may be a central unit (CU) of the distributed RAN 300. The backhaul interface to the next generation core network (NG-CN) 304 may terminate at the ANC. The backhaul interface to neighboring next generation access nodes (NG-ANs) may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

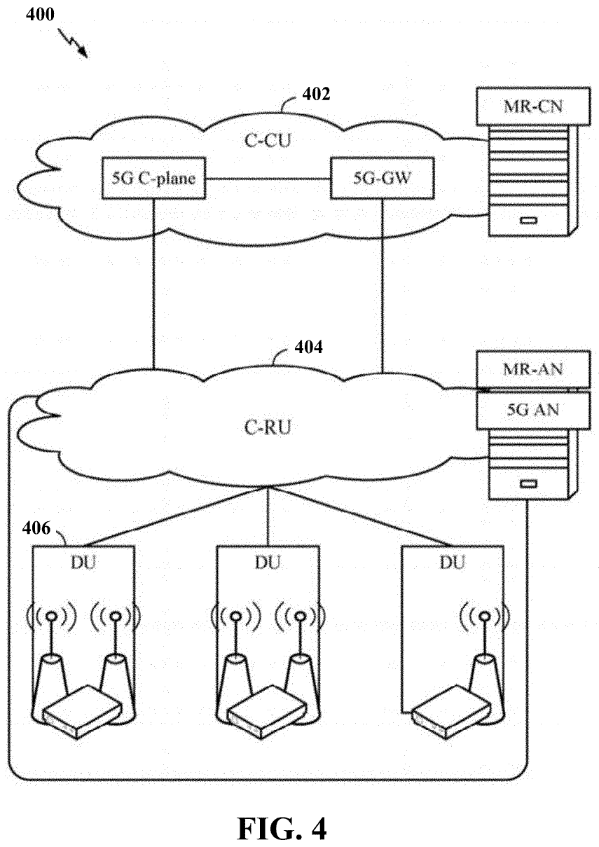

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 606 described above with reference to FIG. 6. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

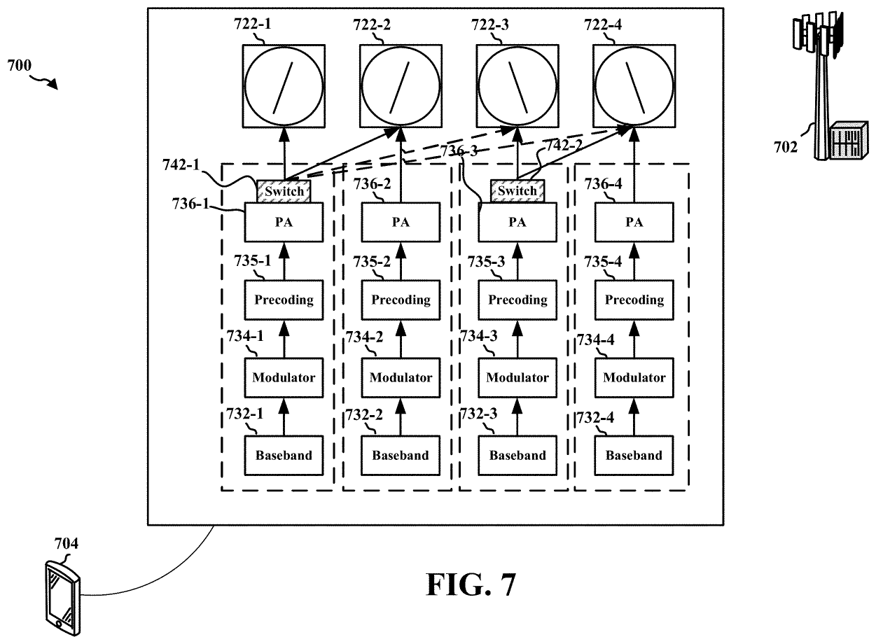

FIG. 7 is a diagram 700 illustrating uplink transmission at a UE 704. In this example, the UE 704 operates antenna ports 722-1, 722-2, 722-3, 722-4 to transmit signals. The antenna ports 722-1, 722-2, 722-3, 722-4 are in connection with transmission chains 730-1, 730-2, 730-3, 730-4 respectively. In particular, in the transmission chain 730-1, a baseband component 732-1 generates baseband signals, which are then modulated by a modulator 734-1. The modulated signals from 734-1, 734-2, 734-3 and 734-4 are sent to a precoding unit 735-1. The signal generated from the precoding 735-1 is amplified by a power amplifier 736-1, which subsequently sends the amplified signal to the antenna port 722-1. Similarly, the transmission chain 730-2 includes a baseband component 732-2, a modulator 734-2, a precoding unit 735-2, and a power amplifier 736-2; the transmission chain 730-3 includes a baseband component 732-3, a modulator 734-3, a precoder 735-3, and a power amplifier 736-3; the transmission chain 730-4 includes a baseband component 732-4, a modulator 734-4, a precoding unit 735-4, and a power amplifier 736-4.

The UE 704 may operate the antenna ports 722-1, 722-2, 722-3, 722-4 and perform fully coherent transmission, partially coherent transmission, or non-coherent transmission based on the capability of the UE 704. When the UE 704 can maintain the phase relationship of the antenna ports 722-1, 722-2, 722-3, 722-4 for a predetermined time period, the antenna ports 722-1, 722-2, 722-3, 722-4 may perform fully coherent transmission. When the UE 704 can only maintain the phase relationship of some (but not all) of the antenna ports 722-1, 722-2, 722-3, 722-4 for a predetermined time period, the antenna ports 722-1, 722-2, 722-3, 722-4 may perform partially coherent transmission. When the UE 704 cannot maintain the phase relationship of any two of the antenna ports 722-1, 722-2, 722-3, 722-4 for a predetermined time period, the antenna ports 722-1, 722-2, 722-3, 722-4 may perform no-coherent transmission. If the UE is equipped with 2 transmission chains, UE capability with fully coherent transmission and non-coherent transmission can be defined in a similar fashion as for a UE equipped with 4 transmission chains.

The UE 704 may further report its capability for supporting coherent transmission to the base station 702. For example, through signaling, the UE 704 may indicate to the base station 702 whether the UE 704 supports full coherent transmission, partially coherent transmission, or only non-coherent transmission.

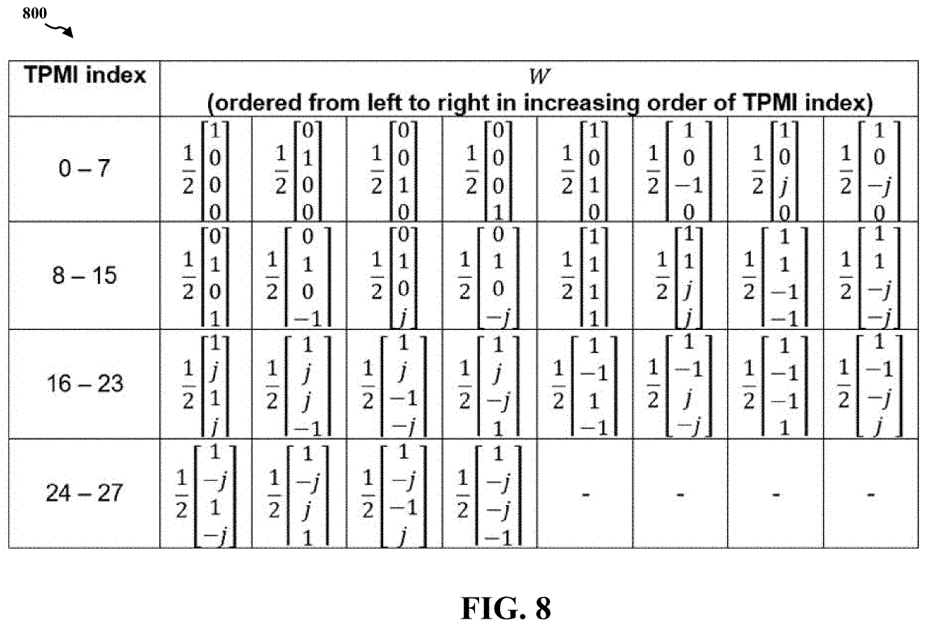

FIG. 8 is a diagram 800 illustrating a codebook 800 including codewords indexed from 0 to 27 that can be used by the precoding units 735-1, 735-2, 735-3, 735-4 in a single layer (i.e., rank 1) with 4 antenna ports. Similarly, respective codebooks can be used for rank 2, rank 3, and rank 4, as well.

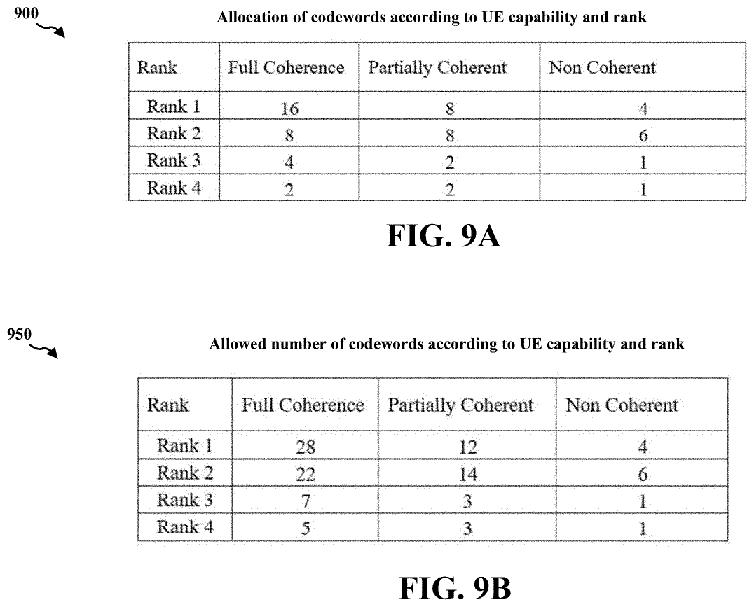

FIG. 9A shows a table 900 listing number of codewords allocated to fully coherent transmission, partially coherent transmission, and non-coherent transmission for rank 1, rank 2, rank 3, and rank 4 as specified in 3GPP Rel-15 NR specifications. For example, in rank 1, 16 codewords are allocated to fully coherent transmission; 8 codewords are allocated to partially coherent transmission; 4 codewords are allocated to non-coherent transmission.

Further, it is disclosed that a partially coherent transmission can also use codewords allocated to non-coherent transmission; a full coherent transmission can also use codewords allocated to both non-coherent transmission and partially coherent transmission.

FIG. 9B shows 950 a table listing number of codewords available for use in a full coherent transmission, a partially coherent transmission, and a non-coherent transmission. For example, in rank 1, 28 codewords are available for a full coherent transmission; 12 codewords are available for a partially coherent transmission; 4 codewords are available for a non-coherent transmission.

The UE 704 may also report its capability for supporting full transmission power uplink transmission. For example, in certain configurations, the UE 704 may indicate to the base station 702 that the power amplifier in each transmission chain on the UE 704 supports full transmission power uplink transmission. In certain configurations, the UE 704 may indicate that no power amplifier on the UE 704 supports full transmission power uplink transmission. In certain configurations, the UE 704 may indicate that only power amplifiers in a subset of transmission chains support full transmission power uplink transmission.

In this example, when the antenna ports 722-1, 722-2, 722-3, 722-4 can only perform non-coherent transmission, the base station 702 transmit a signaling (e.g., through downlink control information in a PDCCH) to the UE 704 to indicate the index number of one of the codewords 0 to 3 in the codebook 800. That is, the codebook 800 is restricted to a subset of 4 codewords available for the UE 704 to use. Each of the codewords is represented by a 4×1 matrix. Each row represents an adjustment to be made to signals to be sent to a particular antenna port. In this example, the first row corresponds to the antenna port 722-1, the second row corresponds to the antenna port 722-2, and so on.

As shown in FIG. 8, each of the codewords 0 to 3 has only 1 row that is not zero. This indicates only 1 antenna port will transmit signals when the antenna ports 722-1, 722-2, 722-3, 722-4 are non-coherent.

The antenna ports 722-1, 722-2, 722-3, 722-4 are divided into 2 groups. The antenna port 722-1 and the antenna port 722-2 form a first group. The antenna port 722-3 and the antenna port 722-4 form a second group. As described supra, each of the antenna ports 722-1, 722-2, 722-3, 722-4 is in connection with a respective transmission chain.

In a first configuration of the UE 704, only one transmission chain in a group has a power amplifier that has a power greater than or equal to a predetermined threshold (i.e., a full transmission power). In this example, the threshold is 23 dBm. More specifically, the power amplifier 736-1 in the transmission chain 730-1 has a power of 23 dBm. The power amplifier 736-3 in the transmission chain 730-3 has a power of 23 dBm. The other power amplifiers (i.e., the power amplifier 736-2 and the power amplifier 736-4) have powers of 17 dBm.

In one scenario, the UE 704 prepares to transmit an uplink channel to the base station 702. Further, the base station 702 indicates to the UE 704 to use codeword 1 in the codebook 800. Accordingly, only antenna port 722-2 will be transmitting signals carrying the uplink channel.

In a first technique, the UE 704 may use the transmission chain 730-2 to generate the signals and then send the signals to the antenna port 722-2. When using this technique, as the power of the power amplifier 736-2 is 17 dBm, the signals is transmitted through the antenna port 722-2 at 17 dBm, which is below the threshold (i.e., 23 dBm).

In a second technique, the output of the power amplifier 736-1 is connected to a switch 742-1, which may switch the amplified signals to either the antenna port 722-1 or the antenna port 722-2. Upon receiving the indication from the base station 702 to apply the codeword 1 to the precoders 735-1, 735-2, 735-3, 735-4, the UE 704 may use the transmission chain 730-1 to generate the signals carrying the uplink channel. The signals are amplified by the power amplifier 736-1, which has a power of 23 dBm. Further, the switch 742-1 disconnects the power amplifier 736-1 from the antenna port 722-1 and connects the power amplifier 736-2 and the antenna port 722-2. As such, the signals amplified by the power amplifier 736-1 are transmitted through the antenna port 722-2. That is, the antenna port 722-2 transmits the signals carrying the uplink channel at a power of 23 dBm.

Similarly, in the second technique, the output of the power amplifier 736-3 is connected to a switch 742-2, which may switch the amplified signals to either the antenna port 722-3 or the antenna port 722-4.

In a second scenario, the base station 702 may send an indication that indicates to the UE 704 to use codeword 3 in the codebook 800. Accordingly, only antenna port 722-4 will be transmitting signals carrying the uplink channel. Upon receiving the indication from the base station 702 to apply the codeword 3 to the precoders 735-1, 735-2, 735-3, 735-4, the UE 704 may use the transmission chain 730-3 to generate the signals carrying the uplink channel. The signals are amplified by the power amplifier 736-3, which has a power of 23 dBm. Further, the switch 742-2 disconnects the power amplifier 736-3 from the antenna port 722-3 and connects the power amplifier 736-3 and the antenna port 722-4. As such, the signals amplified by the power amplifier 736-3 are transmitted through the antenna port 722-4. That is, the antenna port 722-4 transmits the signals carrying the uplink channel at a power of 23 dBm.

In a third scenario, the antenna ports 722-1, 722-2, 722-3, 722-4 may be partially coherent. Accordingly, in addition to the codewords 1 to 3, the base station 702 may also indicates to the UE 704 to apply codewords 4-11 to the precoders 735-1, 735-2, 735-3, 735-4. Further, when the base station 702 indicates a codeword among codewords 8-11, the antenna port 722-2 and the antenna port 722-4 will be used to transmit signals carrying the uplink channel. In the second technique, the UE 704 uses the transmission chain 730-1 and the transmission chain 730-3 to generate the signals carrying the uplink channel, which are amplified by the power amplifier 736-1 and the power amplifier 736-3. Subsequently, as described supra, the switch 742-1 switches the output signals from the power amplifier 736-1 to the antenna port 722-2, and the switch 742-2 switches the output signals from the power amplifier 736-3 to the antenna port 722-4. As such, the antenna port 722-2 and the antenna port 722-4 can transmit the signals carrying the uplink channel at 20 dBm. As such, the total output power of the antenna ports 722-1, 722-2, 722-3, 722-4 may be equal to the threshold (e.g., 23 dBm).

In a second configuration of the UE 704, only one transmission chain of the transmission chains 730-1, 730-2, 730-3, 730-4 has a power amplifier with a power greater than or equal to a first threshold (e.g., 23 dBm, which is the full transmission power). In this example, only the power amplifier 736-1 in the first group has a power of 23 dBm. Only one power amplifier in the second group has a power greater than or equal to a second threshold (e.g., 20 dBm).

In the second scenario described supra, the base station 702 sends an indication that indicates to the UE 704 to use codeword 3 in the codebook 800. Accordingly, only antenna port 722-4 will be transmitting signals carrying the uplink channel. In the second configuration, only the power amplifier 736-1 has a power of 23 dBm.

In a third technique, the switch 742-1 can also connects the power amplifier 736-1 to the antenna port 722-3 and the antenna port 722-4, in addition to the antenna port 722-2. Upon receiving the indication from the base station 702 to apply the codeword 3 to the precoders 735-1, 735-2, 735-3, 735-4, the UE 704 may use the transmission chain 730-1 to generate the signals carrying the uplink channel. The signals are amplified by the power amplifier 736-1, which has a power of 23 dBm. Further, the switch 742-1 disconnects the power amplifier 736-1 from the antenna port 722-1 and connects the power amplifier 736-1 and the antenna port 722-4. As such, the signals amplified by the power amplifier 736-1 are transmitted through the antenna port 722-4. That is, the antenna port 722-4 transmits the signals carrying the uplink channel at a power of 23 dBm.

Similarly, when the base station 702 indicates to the UE 704 to apply the codewords 1 and 2, the UE 704 may also use the transmission chain 730-1 to generate the signals carrying the uplink channel, and then use the switch 742-1 to switch the amplified signals to the antenna port 722-2 or the antenna port 722-3.

In the third scenario described supra, the antenna ports 722-1, 722-2, 722-3, 722-4 may be partially coherent. The base station 702 may also indicates to the UE 704 to apply codewords 3-11 to the precoders 735-1, 735-2, 735-3, 735-4. When the base station 702 indicates a codeword among codewords 8-11, the antenna port 722-2 and the antenna port 722-4 will be used to transmit signals carrying the uplink channel. In this second configuration, as described supra, the power amplifier 736-1 has a power of 23 dBm and the power amplifier 736-3 has a power of 20 dBm.

In the third technique, as in the second technique, the switch 742-2 may switch the amplified signals from the power amplifier 736-3 to either the antenna port 722-3 or the antenna port 722-4. The UE 704 uses the transmission chain 730-1 and the transmission chain 730-3 to generate the signals carrying the uplink channel, which are amplified by the power amplifier 736-1 and the power amplifier 736-3. Subsequently, as described supra, the switch 742-1 switches the output signals from the power amplifier 736-1 to the antenna port 722-2, and the switch 742-2 switches the output signals from the power amplifier 736-3 to the antenna port 722-4. As such, the antenna port 722-2 and the antenna port 722-4 can transmit the signals carrying the uplink channel at 20 dBm. As such, the total output power of the antenna ports 722-1, 722-2, 722-3, 722-4 may be equal to the first threshold (e.g., 23 dBm).

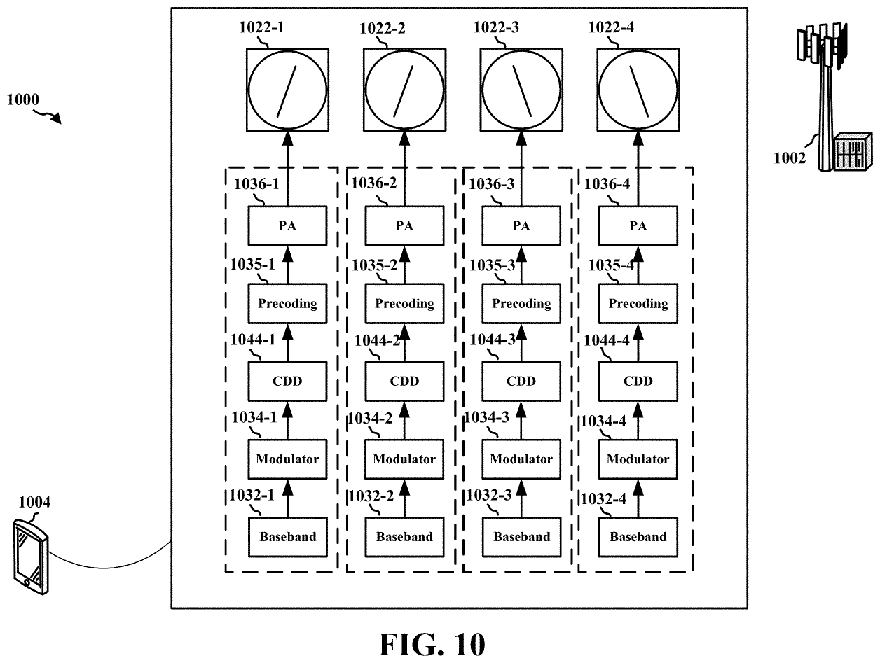

FIG. 10 is a diagram 1000 illustrating uplink transmission at a UE 1004. In this example, the UE 1004 operates antenna ports 1022-1, 1022-2, 1022-3, 1022-4 to transmit signals. The antenna ports 1022-1, 1022-2, 1022-3, 1022-4 are in connection with transmission chains 1030-1, 1030-2, 1030-3, 1030-4 respectively. In particular, in the transmission chain 1030-1, a baseband component 1032-1 generates a baseband signal, which is the modulated by a modulator 1034-1. The modulated signal is sent to a Cyclic Delay Diversity (CDD) component 1044-1, which may apply a cyclic delay to the modulated signal. The output signals from the CDD component 1044-1 are sent to a precoding unit 1035-1 for precoding. The signals generated from the precoder 1035-1 then amplified by a power amplifier 1036-1, which subsequently sends the amplified signal to the antenna port 1022-1. Similarly, the transmission chain 1030-2 includes a baseband component 1032-2, a modulator 1034-2, a CDD component 1044-2, a precoding unit 1035-2, and a power amplifier 1036-2; the transmission chain 1030-3 includes a baseband component 1032-3, a modulator 1034-3, a CDD component 1044-3, a precoding unit 1035-3, and a power amplifier 1036-3; the transmission chain 1030-4 includes a baseband component 1032-4, a modulator 1034-4, a CDD component 1044-4, a precoding unit 1035-4, and a power amplifier 1036-4. It is also possible that the CDD components as shown in FIG. 10 are omitted in a UE implementation.

Depending on the capability of the UE 1004 in terms of fully coherent transmission, partially coherent transmission or non-coherent transmission through a codebook subset restriction (e.g., a bitmap), the base station 1002 signals the selection of codewords at each rank. The number of chosen codewords at each rank at a reported UE capability are shown in FIG. 9B.

In this example, the UE 1004 may have a configuration that only supports non-coherent uplink transmission or partially coherent uplink transmission, but not coherent transmission. The base station 1002 may indicates to the UE 1004 that only a subset of the codewords in the codebook 800 are to be used. Accordingly, the UE 1004 can determine that an indication indicating a codeword index and received from the base station 1002 accordingly would indicate a codeword in the subset. The codewords in the subset are re-indexed sequentially then the relevant DCI field size does not change with respect to the 3GPP Rel-15 NR standards.

In this example, the power amplifier 1036-1, the power amplifier 1036-2, the power amplifier 1036-3, and the power amplifier 1036-4 each have a power less than the threshold (23 dB), e.g., at 17 dBm.

In a fourth technique, the base station 1002 received an indication from the UE 1004 indicating that none of the power amplifiers supports full power (e.g., at 23 dBm) uplink transmission. The base station 1002 indicates to the UE 1004 that only a subset of the codebook 800 including one or more fully coherent codeword, for example the codeword 12, the codeword 14, the codeword 20, and the codeword 22 may be used on the precoders 1035-1, 1035-2, 1035-3, 1035-4. The selection can be through a bitmap e.g., [0000 0000 0000 1010 0000 1010 0000] for the selected words for rank 1, and similarly for selected codewords for other ranks.

Accordingly, the UE 1004 re-index the codeword 12, the codeword 14, the codeword 20, and the codeword 22 as new codeword 0, new codeword 1, new codeword 2, and new codeword 3. According to the new codewords, each of the antenna ports 1022-1, 1022-2, 1022-3, 1022-4 will be used to transmit signals carrying the uplink channel.

The base station 1002 can use index 0 to 3 (e.g., via 2 bits) to indicate the codeword 12, the codeword 14, the codeword 20, and the codeword 22 in the codebook 800 (i.e., the new codeword 0, the new codeword 1, the new codeword 2, and the new codeword 3 in the subset).

The UE 1004 receives the index of a codeword in the subset, and accordingly determines the codeword to be applied to the precoders 1035-1, 1035-2, 1035-3, 1035-4. As each of the antenna ports 1022-1, 1022-2, 1022-3, 1022-4 is used, the UE 1004 uses each of the transmission chains 1030-1, 1030-2, 1030-3, 1030-4 to generate the signals carrying the uplink channel. The basebands components 1032-1, 1032-2, 1032-3, 1032-4 generate base band signals, which are input into the modulators 1034-1, 1034-2, 1034-3, 1034-4. In this technique, the modulated signals are input into the CDD components 1044-1, 1044-2, 1044-3, 1044-4, which may selectively apply respective cyclic delays to the respective modulated signals.

In one example, for each spatial layer, a first set of entries, e.g., the entries corresponding to the same coherence group (e.g., the antenna port 1022-1 and the antenna port 1022-3) are transmitted from relevant transmission chains at the same time, while other entries (e.g., the antenna port 1022-2 and the antenna port 1022-4) are transmitted at a different timing from the first set of entries. More specifically, suppose tₖ is the small cyclic delay introduced at transmission chains 1030-1, 1030-2, 1030-3, 1030-4, where 1≤k≤4: for a UE reporting non-coherent transmission capability, tₘ≠tₙ, where 1≤m, n≤4, m≠n; for a UE reporting partially-coherent transmission capability, t₁=t₃≠t₂=t₄.

As described supra, the UE 1004 reports its coherence transmission capability to the network (non-coherence, partial coherence, full coherence) via the base station 1002. The allowed number of codewords at each rank is looked up from the table in FIG. 9B by the base station 1002. According to the reported coherence transmission capability: a corresponding number of codewords out of all the codewords that may be originally designed for non-coherence, partial coherence, full coherence, at a given rank (e.g., through a bitmap for each rank) is chosen, and the chosen codewords are eligible to be indicated by the base station 1002 to be used by the UE. More specifically for a UE reporting non-coherent transmission capability, the codebook subset restriction or the chosen codewords may include a codeword originally designed for partially coherent transmission or fully coherent transmission; for a UE reporting partially coherent transmission capability, the codebook subset restriction or the chosen codewords may include a codeword originally designed for fully coherent transmission. The base station 1002 can configure the UE to use codebook subset restriction (e.g., the selection described supra in the fourth technique) in an RRC signaling to the UE 1004.

The base station 1002 can also configure multiple sets of codebook subset restriction to the UE 1004. By using MAC CE, the active codebook subset restriction can be selected at the UE 1004. The UE 1004 receives the RRC signaling for the configuration of one or multiple codebook subset restriction(s) and potentially MAC CE activation/selection. The selected codewords at each rank may be indexed sequentially as the “1”'s positions in the bitmap. When the UE 1004 receives a DCI, the relevant fields concerning TMPI can be construed accordingly.

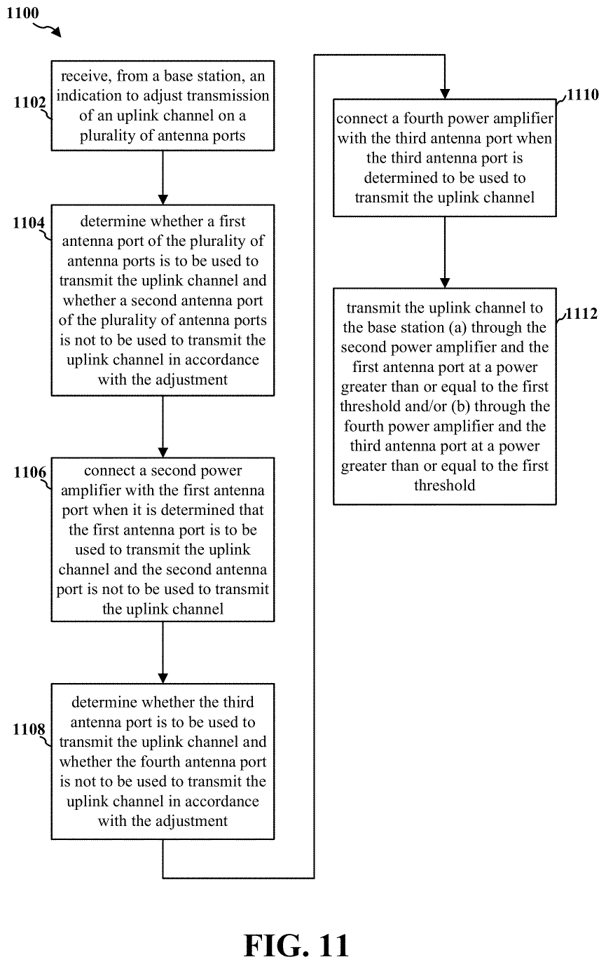

FIG. 11 is a flow chart 1100 of a method (process) for transmitting an uplink channel. The method may be performed by a UE (e.g., the UE 704, the apparatus 1302, and the apparatus 1302′).

At operation 1102 the UE receives, from a base station, an indication to adjust transmission of an uplink channel on a plurality of antenna ports. In certain configurations, the indication indicates a codeword in a codebook to be used by a precoder of the UE when transmitting the uplink channel through one or more of the plurality of antenna ports. At operation 1104, the UE determines whether a first antenna port of the plurality of antenna ports is to be used to transmit the uplink channel and whether a second antenna port of the plurality of antenna ports is not to be used to transmit the uplink channel in accordance with the adjustment. A first power amplifier is in a first transmission chain in connection with the first antenna port. A maximum power of the first power amplifier is lower than a first threshold.

At operation 1106, the UE connects a second power amplifier with the first antenna port when it is determined that the first antenna port is to be used to transmit the uplink channel and the second antenna port is not to be used to transmit the uplink channel. The second power amplifier is in a second transmission chain in connection with the second antenna port. A maximum power of the second power amplifier being greater than or equal to the first threshold.

In certain configurations, the first antenna port and the second antenna port are in a first group of antenna ports. A third antenna port and a fourth antenna port of the plurality of antenna ports are in a second group of antenna ports. At operation 1108, the UE determines whether the third antenna port is to be used to transmit the uplink channel and whether the fourth antenna port is not to be used to transmit the uplink channel in accordance with the adjustment. A third power amplifier is in a third transmission chain in connection with the third antenna port. A maximum power of the third power amplifier is lower than the first threshold.

At operation 1110, the UE connects a fourth power amplifier with the third antenna port when the third antenna port is determined to be used to transmit the uplink channel. The fourth power amplifier being in a fourth transmission chain in connection with the fourth antenna port. A maximum power of the fourth power amplifier being greater than or equal to the first threshold. In certain configurations, only one of the first antenna port, the second antenna port, the third antenna port, and the fourth antenna port is determined to be used to transmit the uplink channel. In certain configurations, a respective one antenna port from each of the first group and the second group is determined to be used to transmit the uplink channel.

At operation 1112, the UE transmits the uplink channel to the base station through (a) the second power amplifier and the first antenna port at a power greater than or equal to the first threshold and/or (b) through the fourth power amplifier and the third antenna port at a power greater than or equal to the first threshold.

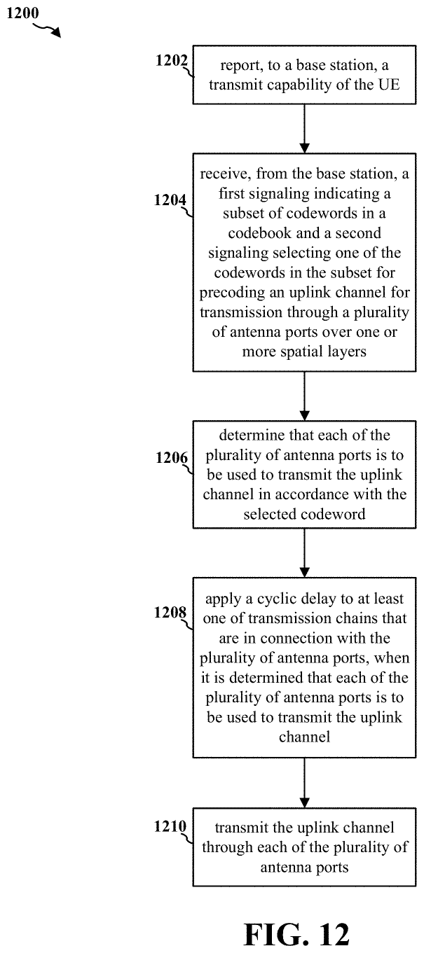

FIG. 12 is a flow chart 1200 of a method (process) for transmitting an uplink channel. The method may be performed by a UE (e.g., the UE 704, the apparatus 1302, and the apparatus 1302′).

At operation 1202, the UE reports, to a base station, a transmit capability of the UE. At operation 1204, the UE receives, from the base station, a first signaling indicating a subset of codewords in a codebook and a second signaling selecting one of the codewords in the subset for precoding an uplink channel for transmission through a plurality of antenna ports over one or more spatial layers. In certain configurations, the second signaling includes an index referencing a codeword in the subset of codewords.

At operation 1206, the UE determines that each of the plurality of antenna ports is to be used to transmit the uplink channel in accordance with the selected codeword. At operation 1208, the UE applies a cyclic delay to at least one of transmission chains that are in connection with the plurality of antenna ports, when it is determined that each of the plurality of antenna ports is to be used to transmit the uplink channel. At operation 1210, the UE transmits the uplink channel through each of the plurality of antenna ports.

In certain configurations, the reported transmit capability of the UE indicates non-coherent transmission. A codeword in the subset indicated by the first signaling is a precoder of the UE and adjusts the UE to transmit the uplink channel of one spatial layer with non-zero power on two or more antenna ports of the plurality of antenna ports. In certain configurations, the reported transmit capability of the UE indicates partially-coherent transmission. A codeword in the subset indicated by the first signaling is a precoder of the UE and adjusts the UE to transmit the uplink channel of one spatial layer with non-zero power on all of the plurality of antenna ports.

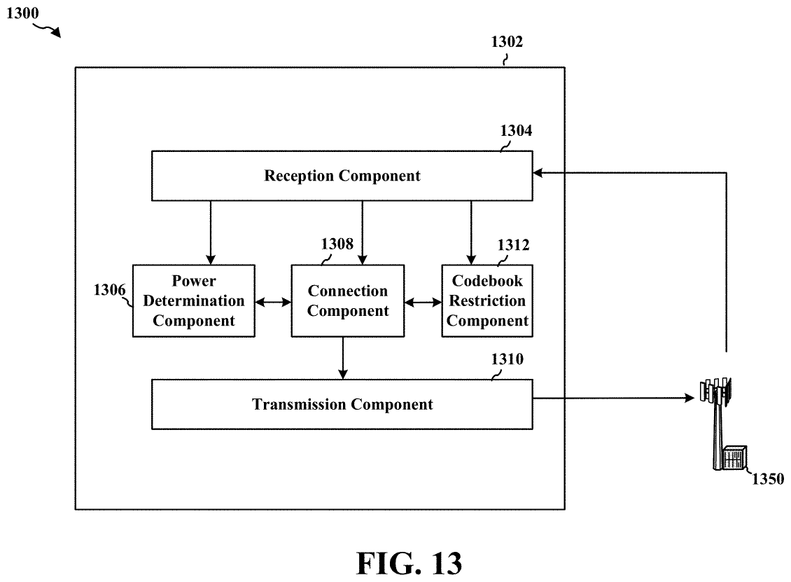

FIG. 13 is a conceptual data flow diagram 1300 illustrating the data flow between different components/means in an exemplary apparatus 1302. The apparatus 1302 may be a UE. The apparatus 1302 includes a reception component 1304, a power determination component 1306, a connection component 1308, a codebook restriction component 1312, and a transmission component 1310.

In one aspect, the reception component 1304 receives, from a base station, an indication to adjust transmission of an uplink channel on a plurality of antenna ports. In certain configurations, the indication indicates a codeword in a codebook to be used by a precoder of the UE when transmitting the uplink channel through one or more of the plurality of antenna ports. The UE powers whether a first antenna port of the plurality of antenna ports is to be used to transmit the uplink channel and whether a second antenna port of the plurality of antenna ports is not to be used to transmit the uplink channel in accordance with the adjustment. A first power amplifier is in a first transmission chain in connection with the first antenna port. A maximum power of the first power amplifier is lower than a first threshold.

The connection component 1308 connects a second power amplifier with the first antenna port when it is determined that the first antenna port is to be used to transmit the uplink channel and the second antenna port is not to be used to transmit the uplink channel. The second power amplifier is in a second transmission chain in connection with the second antenna port. A maximum power of the second power amplifier being greater than or equal to the first threshold.

In certain configurations, the first antenna port and the second antenna port are in a first group of antenna ports. A third antenna port and a fourth antenna port of the plurality of antenna ports are in a second group of antenna ports. The UE determines whether the third antenna port is to be used to transmit the uplink channel and whether the fourth antenna port is not to be used to transmit the uplink channel in accordance with the adjustment. A third power amplifier is in a third transmission chain in connection with the third antenna port. A maximum power of the third power amplifier is lower than the first threshold.

The connection component 1308 connects a fourth power amplifier with the third antenna port when the third antenna port is determined to be used to transmit the uplink channel. The fourth power amplifier being in a fourth transmission chain in connection with the fourth antenna port. A maximum power of the fourth power amplifier being greater than or equal to the first threshold. In certain configurations, only one of the first antenna port, the second antenna port, the third antenna port, and the fourth antenna port is determined to be used to transmit the uplink channel. In certain configurations, a respective one antenna port from each of the first group and the second group is determined to be used to transmit the uplink channel.

The transmission component 1310 transmits the uplink channel to the base station through (a) the second power amplifier and the first antenna port at a power greater than or equal to the first threshold and/or (b) through the fourth power amplifier and the third antenna port at a power greater than or equal to the first threshold.

In another aspect, the power determination component 1306 reports, to a base station 1350, a transmit capability of the UE. The codebook restriction component 1312 receives, from the base station, a first signaling indicating a subset of codewords in a codebook and a second signaling selecting one of the codewords in the subset for precoding an uplink channel for transmission through a plurality of antenna ports over one or more spatial layers. In certain configurations, the second signaling includes an index referencing a codeword in the subset of codewords.

The power determination component 1306 determines that each of the plurality of antenna ports is to be used to transmit the uplink channel in accordance with the selected codeword. The power determination component 1306 applies a cyclic delay to at least one of transmission chains that are in connection with the plurality of antenna ports, when it is determined that each of the plurality of antenna ports is to be used to transmit the uplink channel. The transmission component 1310 transmits the uplink channel through each of the plurality of antenna ports.

In certain configurations, the reported transmit capability of the UE indicates non-coherent transmission. A codeword in the subset indicated by the first signaling is a precoder of the UE and adjusts the UE to transmit the uplink channel of one spatial layer with non-zero power on two or more antenna ports of the plurality of antenna ports. In certain configurations, the reported transmit capability of the UE indicates partially-coherent transmission. A codeword in the subset indicated by the first signaling is a precoder of the UE and adjusts the UE to transmit the uplink channel of one spatial layer with non-zero power on all of the plurality of antenna ports.

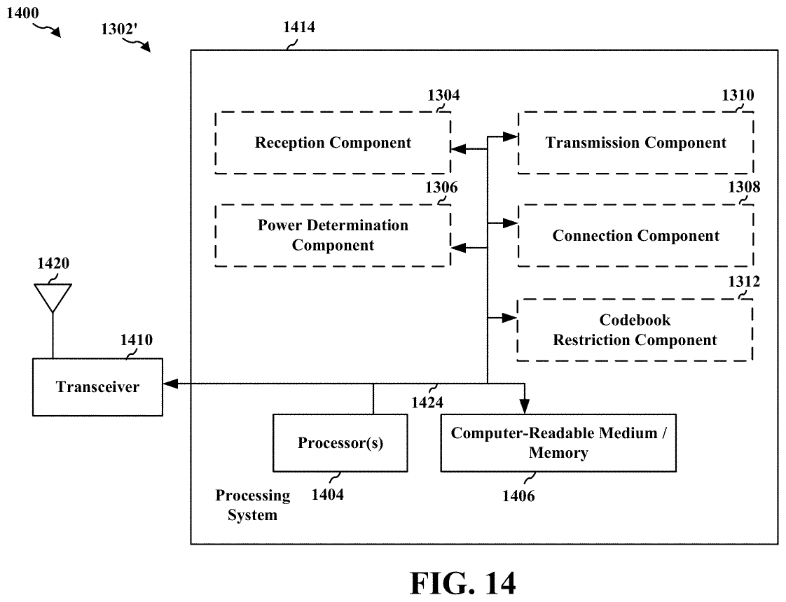

FIG. 14 is a diagram 1400 illustrating an example of a hardware implementation for an apparatus 1302′ employing a processing system 1414. The apparatus 1302′ may be a UE. The processing system 1414 may be implemented with a bus architecture, represented generally by a bus 1424. The bus 1424 may include any number of interconnecting buses and bridges depending on the specific application of the processing system 1414 and the overall design constraints. The bus 1424 links together various circuits including one or more processors and/or hardware components, represented by one or more processors 1404, the reception component 1304, the power determination component 1306, the connection component 1308, the codebook restriction component 1312, and the transmission component 1310, and a computer-readable medium/memory 1406. The bus 1424 may also link various other circuits such as timing sources, peripherals, voltage regulators, and power management circuits, etc.

The processing system 1414 may be coupled to a transceiver 1410, which may be one or more of the transceivers 254. The transceiver 1410 is coupled to one or more antennas 1420, which may be the communication antennas 252.

The transceiver 1410 provides a means for communicating with various other apparatus over a transmission medium. The transceiver 1410 receives a signal from the one or more antennas 1420, extracts information from the received signal, and provides the extracted information to the processing system 1414, specifically the reception component 1304. In addition, the transceiver 1410 receives information from the processing system 1414, specifically the transmission component 1310, and based on the received information, generates a signal to be applied to the one or more antennas 1420.

The processing system 1414 includes one or more processors 1404 coupled to a computer-readable medium/memory 1406. The one or more processors 1404 are responsible for general processing, including the execution of software stored on the computer-readable medium/memory 1406. The software, when executed by the one or more processors 1404, causes the processing system 1414 to perform the various functions described supra for any particular apparatus. The computer-readable medium/memory 1406 may also be used for storing data that is manipulated by the one or more processors 1404 when executing software. The processing system 1414 further includes at least one of the reception component 1304, the power determination component 1306, the connection component 1308, the codebook restriction component 1312, and the transmission component 1310. The components may be software components running in the one or more processors 1404, resident/stored in the computer readable medium/memory 1406, one or more hardware components coupled to the one or more processors 1404, or some combination thereof. The processing system 1414 may be a component of the UE 250 and may include the memory 260 and/or at least one of the TX processor 268, the RX processor 256, and the communication processor 259.

In one configuration, the apparatus 1302/apparatus 1302′ for wireless communication includes means for performing each of the operations of FIGS. 11-12. The aforementioned means may be one or more of the aforementioned components of the apparatus 1302 and/or the processing system 1414 of the apparatus 1302′ configured to perform the functions recited by the aforementioned means.

As described supra, the processing system 1414 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, from a base station, an indication to adjust transmission of an uplink channel on a plurality of antenna ports;
determining whether a first antenna port of the plurality of antenna ports is to be used to transmit the uplink channel and whether a second antenna port of the plurality of antenna ports is not to be used to transmit the uplink channel in accordance with the adjustment, a first power amplifier being in a first transmission chain in connection with the first antenna port, a maximum power of the first power amplifier being lower than a first threshold;
connecting a second power amplifier with the first antenna port when it is determined that the first antenna port is to be used to transmit the uplink channel and the second antenna port is not to be used to transmit the uplink channel, the second power amplifier being in a second transmission chain in connection with the second antenna port, a maximum power of the second power amplifier being greater than or equal to the first threshold; and
transmitting the uplink channel to the base station through the second power amplifier and the first antenna port at a power greater than or equal to the first threshold.

2. The method of claim 1, wherein the indication indicates a codeword in a codebook to be used by a precoder of the UE when transmitting the uplink channel through one or more of the plurality of antenna ports.

3. The method of claim 1, wherein the first antenna port and the second antenna port are in a first group of antenna ports, wherein a third antenna port and a fourth antenna port of the plurality of antenna ports are in a second group of antenna ports, the method further comprising:
determining whether the third antenna port is to be used to transmit the uplink channel and whether the fourth antenna port is not to be used to transmit the uplink channel in accordance with the adjustment, a third power amplifier being in a third transmission chain in connection with the third antenna port, a maximum power of the third power amplifier being lower than the first threshold;
connecting a fourth power amplifier with the third antenna port when the third antenna port is determined to be used to transmit the uplink channel, the fourth power amplifier being in a fourth transmission chain in connection with the fourth antenna port, a maximum power of the fourth power amplifier being greater than or equal to the first threshold; and
transmitting the uplink channel through the fourth power amplifier and the third antenna port at a power greater than or equal to the first threshold.

4. The method of claim 3, wherein only one of the first antenna port, the second antenna port, the third antenna port, and the fourth antenna port is determined to be used to transmit the uplink channel.

5. The method of claim 3, wherein a respective one antenna port from each of the first group and the second group is determined to be used to transmit the uplink channel.

6. A method of wireless communication of a user equipment (UE), comprising:
reporting, to a base station, a transmit capability of the UE; and
receiving, from the base station, a first signaling indicating a subset of codewords in a codebook and a second signaling selecting one of the codewords in the subset for precoding an uplink channel for transmission through a plurality of antenna ports over one or more spatial layers.

7. The method of claim 6, further comprising:
determining that each of the plurality of antenna ports is to be used to transmit the uplink channel in accordance with the selected codeword;
applying a cyclic delay to at least one of transmission chains that are in connection with the plurality of antenna ports, when it is determined that each of the plurality of antenna ports is to be used to transmit the uplink channel; and
transmitting the uplink channel through each of the plurality of antenna ports.

8. The method of claim 6, wherein the second signaling includes an index referencing a codeword in the subset of codewords.

9. The method of claim 6, wherein the reported transmit capability of the UE indicates non-coherent transmission, wherein a codeword in the subset indicated by the first signaling is a precoder of the UE and adjusts the UE to transmit the uplink channel of one spatial layer with non-zero power on two or more antenna ports of the plurality of antenna ports.

10. The method of claim 6, wherein the reported transmit capability of the UE indicates partially-coherent transmission, wherein a codeword in the subset indicated by the first signaling is a precoder of the UE and adjusts the UE to transmit the uplink channel of one spatial layer with non-zero power on all of the plurality of antenna ports.

11. An apparatus for wireless communication, the apparatus being a user equipment (UE), comprising:
a memory; and
at least one processor coupled to the memory and configured to:
receive, from a base station, an indication to adjust transmission of an uplink channel on a plurality of antenna ports;
determine whether a first antenna port of the plurality of antenna ports is to be used to transmit the uplink channel and whether a second antenna port of the plurality of antenna ports is not to be used to transmit the uplink channel in accordance with the adjustment, a first power amplifier being in a first transmission chain in connection with the first antenna port, a maximum power of the first power amplifier being lower than a first threshold;
connect a second power amplifier with the first antenna port when it is determined that the first antenna port is to be used to transmit the uplink channel and the second antenna port is not to be used to transmit the uplink channel, the second power amplifier being in a second transmission chain in connection with the second antenna port, a maximum power of the second power amplifier being greater than or equal to the first threshold; and
transmit the uplink channel to the base station through the second power amplifier and the first antenna port at a power greater than or equal to the first threshold.

12. The apparatus of claim 11, wherein the indication indicates a codeword in a codebook to be used by a precoder of the UE when transmitting the uplink channel through one or more of the plurality of antenna ports.

13. The apparatus of claim 11, wherein the first antenna port and the second antenna port are in a first group of antenna ports, wherein a third antenna port and a fourth antenna port of the plurality of antenna ports are in a second group of antenna ports, wherein the at least one processor is further configured to:
determine whether the third antenna port is to be used to transmit the uplink channel and whether the fourth antenna port is not to be used to transmit the uplink channel in accordance with the adjustment, a third power amplifier being in a third transmission chain in connection with the third antenna port, a maximum power of the third power amplifier being lower than the first threshold;
connect a fourth power amplifier with the third antenna port when the third antenna port is determined to be used to transmit the uplink channel, the fourth power amplifier being in a fourth transmission chain in connection with the fourth antenna port, a maximum power of the fourth power amplifier being greater than or equal to the first threshold; and
transmit the uplink channel through the fourth power amplifier and the third antenna port at a power greater than or equal to the first threshold.

14. The apparatus of claim 13, wherein only one of the first antenna port, the second antenna port, the third antenna port, and the fourth antenna port is determined to be used to transmit the uplink channel.

15. The apparatus of claim 13, wherein a respective one antenna port from each of the first group and the second group is determined to be used to transmit the uplink channel.

16. An apparatus for wireless communication, the apparatus being a user equipment (UE), comprising:
a memory; and
at least one processor coupled to the memory and configured to:
report, to a base station, a transmit capability of the UE; and
receive, from the base station, a first signaling indicating a subset of codewords in a codebook and a second signaling selecting one of the codewords in the subset for precoding an uplink channel for transmission through a plurality of antenna ports over one or more spatial layers.

17. The apparatus of claim 16, wherein the at least one processor is further configured to:
determine that each of the plurality of antenna ports is to be used to transmit the uplink channel in accordance with the selected codeword;
apply a cyclic delay to at least one of transmission chains that are in connection with the plurality of antenna ports, when it is determined that each of the plurality of antenna ports is to be used to transmit the uplink channel; and
transmit the uplink channel through each of the plurality of antenna ports.

18. The apparatus of claim 16, wherein the second signaling includes an index referencing a codeword in the subset of codewords.

19. The apparatus of claim 16, wherein the reported transmit capability of the UE indicates non-coherent transmission, wherein a codeword in the subset indicated by the first signaling is a precoder of the UE and adjusts the UE to transmit the uplink channel of one spatial layer with non-zero power on two or more antenna ports of the plurality of antenna ports.

20. The apparatus of claim 16, wherein the reported transmit capability of the UE indicates partially-coherent transmission, wherein a codeword in the subset indicated by the first signaling is a precoder of the UE and adjusts the UE to transmit the uplink channel of one spatial layer with non-zero power on all of the plurality of antenna ports.
